(19) United States
(12) Patent Application Publication
(10) Pub. No.: US 2020/0066183 A1
(43) Pub. Date: Feb. 27, 2020

(54) APPARATUS FOR PRACTICING REMOVAL OF A DEFORMATIVE DAMAGE TO A WORKPIECE

(71) Applicant: Jeremy langton, St Joseph, MO (US)

(72) Inventor: Jeremy langton, St Joseph, MO (US)

(21) Appl. No.: 16/112,643

(22) Filed: Aug. 25, 2018

(51) Int. Cl. G09B 19/24

(52) U.S. Cl. CPC G09B 19/24

(57) ABSTRACT

Disclosed is an apparatus for practicing removal of a deformative damage to a workpiece. The apparatus includes a metallic frame having a cover disposed thereon. The metallic frame is configured to receive the workpiece. The metallic frame is further provided with predetermined number of holes on side surface of each of its walls. The metallic frame further includes protrusions provided at least at each corner of the metallic frame. The cover is provided with predetermined number of holes on its top surface. The apparatus further includes supporting legs connected with the metallic frame at one end and resting on a surface at the other end. Furthermore, the apparatus includes a securing structure configured to firmly secure the supporting legs on the surface, wherein the workpiece comprises of holes at least to receive the protrusions provided at least at each corner of the metallic frame in an event the workpiece is placed on the metallic frame with the cover disposed thereon.

### TECHNICAL FIELD

The present invention relates to paintless dent removal, and more particularly relates to a training module for paintless dent removal or paintless dent repair.

### BACKGROUND

Typically, paintless dent removal is the process of removing dents from a vehicle's surface panels without the use of fillers, sanding, or painting. Conventionally, to learn this technique, a user must participate in classroom trainings to get access to expensive and large training machines for practising this art. However, the classroom trainings are limited in number and due to high fee schedules and costs, classroom trainings are not accessible to every user. Further, classroom trainings are run for a fixed schedule, therefore by the end of a session of the classroom training, if a user is not able to learn and practice sufficiently, it creates an undesirable situation for the user wherein the user has to again participate in trainings which becomes a costly affair for the user.

In an event, a user wants to learn this technique on their own, still the user need automobile panels to practice on, which are not easily available. Apart from the automobile panels, the user need a big space and other infrastructure to practice with these panels which creates hindrance in learning paintless dent removal.

Therefore, there is a need to alleviate the problems existing in the prior arts.

### SUMMARY

In view of the above, it is an objective of the present invention to solve or at least reduce the problems discussed above. In accordance with an embodiment of the present invention, there is provided an apparatus for practicing removal of a deformative damage to a workpiece. The apparatus includes a metallic frame having a cover disposed thereon, the metallic frame configured to receive the workpiece, wherein a predetermined number of holes are present on a side surface of each wall of the metallic frame and on a top surface of the cover, and wherein protrusions are provided at least at each corner of the metallic frame. Furthermore, the apparatus includes supporting legs connected with the metallic frame at one end and resting on a surface at the other end. Furthermore, the apparatus includes a securing structure configured to firmly secure the supporting legs on the surface, wherein the workpiece comprising a plurality of holes at least to receive the protrusions provided at least at each corner of the metallic frame in an event the workpiece is placed on the metallic frame with the cover disposed on the metallic frame.

### BRIEF DESCRIPTION OF THE DRAWINGS

The invention will be described in more details with reference to the enclosed drawings, wherein:

FIG. 1 illustrates a perspective view of an apparatus for practicing removal of a deformative damage to a workpiece, according to an embodiment of the present invention;

FIG. 2 is a closer perspective view of the apparatus of FIG. 1;

FIG. 3 is a top view of the workpiece of FIG. 1;

FIG. 4 is a top of a cover of a metallic frame of the apparatus of FIG. 1;

FIG. 5 illustrate another close perspective view of the apparatus of FIG. 1; and

FIG. 6-7 illustrate a perspective view of the apparatus of FIG. 1 according to another embodiment of the present invention.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures/accompanying diagrams depict a simplified structure only showing some elements and functional entities, all being logical units whose implementation may differ from what is shown. The connections shown are logical connections; the actual physical connections may be different.

The present invention discloses an apparatus for practicing removal of a deformative damage to a workpiece. In an embodiment, the apparatus (102) may be used to practise Paintless Dent Removal (PDR) process. The apparatus (102) is portable, compact in size, and is used as a paintless dent removal training module. Because of the portability and compactness, the user may carry the apparatus (102) for practising PDR wherever they want, which provides freedom to the user to learn PDR on their own pace. Because of low cost training material and practising sheets used in the apparatus (102), the apparatus (102) is cost effective and affordable by users. The apparatus (102) is easy to handle, store, and is easy to set-up for practising PDR process.

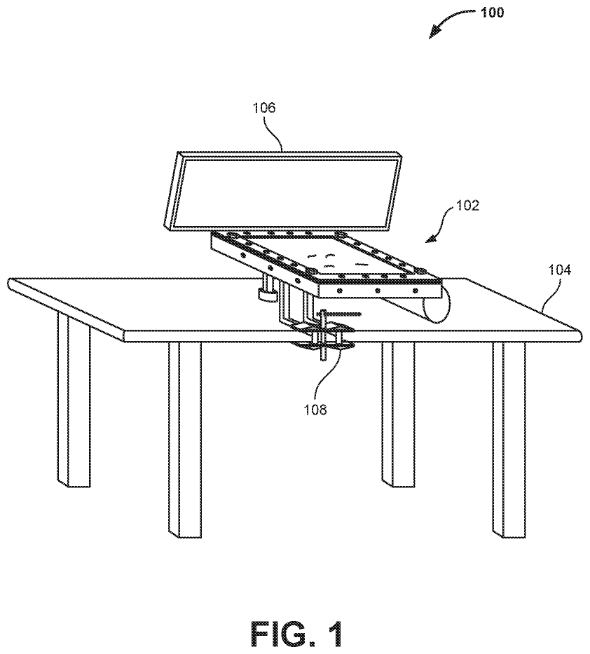

A perspective view of a system (100) is disclosed in FIG. 1. The system (100) includes the apparatus (102) secured on a surface (104). The system (100) further includes a lighting module (106) positioned on the surface (104) along with the apparatus (102), wherein the lighting module (106) is configured to throw light on the apparatus (102) during an operative condition. The apparatus (102) is secured on the surface (104) by a securing structure (108). In an exemplary embodiment, the surface (104) is a table. However, the surface (104) is not limited to a table, and any other mechanical structure may be used for holding the apparatus (102). In an embodiment, the securing structure (108) is a vice.

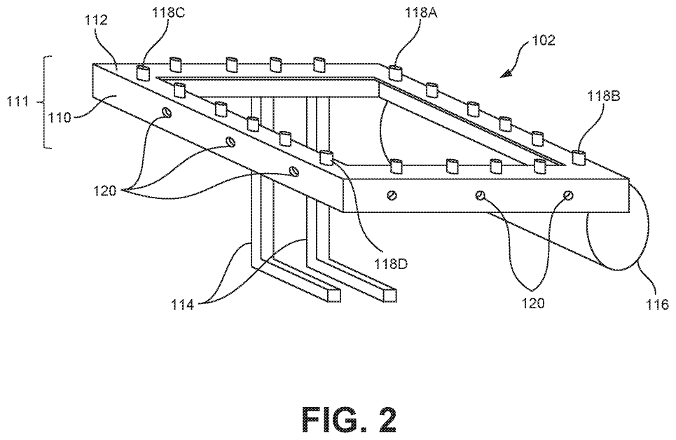

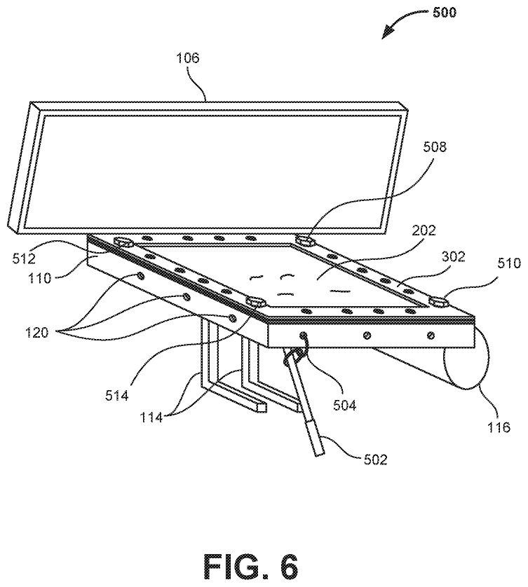

A closer perspective view of the apparatus (102) is disclosed in FIG. 2. The apparatus (102) includes a metallic frame (111) coupled with supporting legs (114). A plurality of holes (120) is present on a side surface (110) of each wall of the metallic frame (111). The number of holes on the side surface (110) is not fixed and depends on dimensions of the walls of the metallic frame (111). A top surface (112) of each wall of the metallic frame (111) includes protrusions. The protrusions are predetermined distance apart from each other and the number of protrusions present on each wall of the metallic frame (111) depends on the dimensions of the metallic frame (111). In an embodiment, the protrusions may be present at four corners on the top surface (112) of each wall of the metallic frame (111). In another embodiment, the protrusions may be present along the longitudinal length on the top surface (112) of each of the walls of the metallic frame (111) including the four corners. The protrusions are configured to receive a workpiece (200) thereon. Specifically, the protrusions (118A, 118B, 118C, 118D) present at four corners of the metallic frame (111) are further configured to receive nuts (508, 510, 512, 514) thereon, after receiving the workpiece (200), as shown in FIG. 6. A metallic tube (116) which is cylindrical in shape, is coupled with the metallic frame (111) with the help of connectors (121). In an example, the metallic tube (116) may be present on any side of the metallic frame (111).

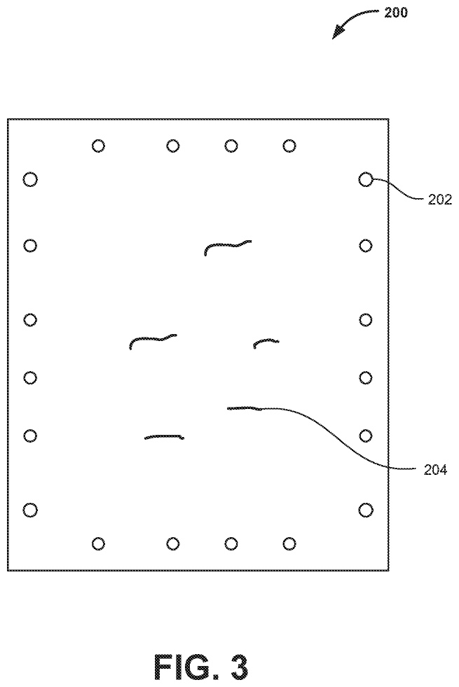

FIG. 3 illustrates a top view of the workpiece (200) having deformative damages (204). Example of the deformative damages (204) includes dents. The workpiece (200) includes a plurality of holes (202) present in such a manner so as to be complementary with protrusions present on the metallic frame (111). In an operative condition, the workpiece (200) is placed on the metallic frame (111), due to which protrusions present on the metallic frame (111) are received by the holes (202) present on the workpiece (200). Due to the reception of the holes (202) by the respective protrusion present on the metallic frame (111), the workpiece (200) is properly fixed on the metallic frame (111) which enables stability while practising the PDR process. After the protrusions on the metallic frame (111) are received by the respective holes (202) of the workpiece (200), a cover (300) is disposed on the metallic frame (111). Thereafter, nuts (508, 510, 512, 514) are placed and tightened over the protrusions (118A, 118B, 118C, 118D) present on four corners of the metallic frame (111), as shown in FIG. 6. The deformative damages (204) present in the workpiece (200) are removed by a user during training on the workpiece (200). In an embodiment, the workpiece (200) is a metallic sheet of size equal to size of the metallic frame (111). Since, the workpiece (200) is a metallic sheet, it is easy to arrange the metallic sheet as compared to automobile panels, thereby increasing convenience to users. Further, the cost of the metallic sheet is much less as compared to automobile panels, the workpiece (200) becomes cost effective, thereby giving freedom to users to practice as many times as they want.

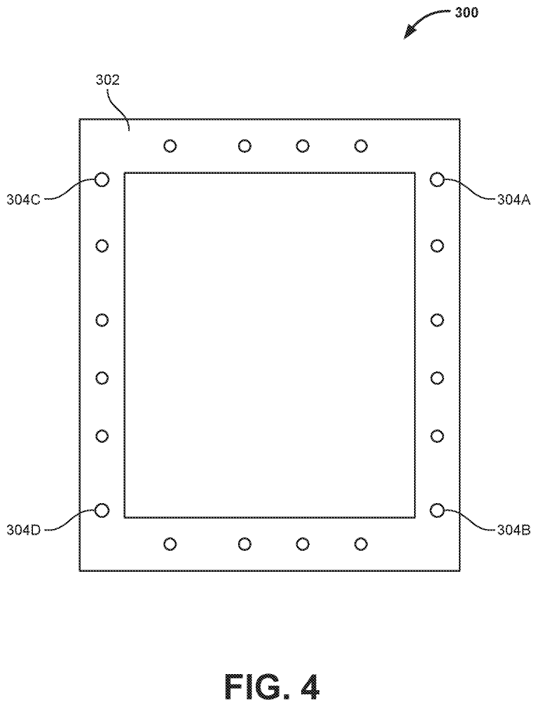

FIG. 4 illustrates a top view of the cover (300) which is placed on the top surface (112) of the metallic frame (111). The cover (300) includes predetermined number of holes on a top side (302), which are punched apart from each other in such a manner to be complementary with protrusions present on the top surface (112) when placed on the top surface (112) of the metallic frame (111). Specifically, the protrusions (118A, 118B, 118C, 118D) are configured to be of length such that when the cover (300) is placed on top of the metallic frame (111), the protrusions (118A, 118B, 118C, 118D) are received by the holes (304A, 304B, 304C, 304D) present on the cover (300). Further, when the cover (300) is placed on top of the workpiece (200), the protrusions (118A, 118B, 118C, 118D) coming out of the holes (202) present on four corners of the workpiece (200) are further received by the holes (304A, 304B, 304C, 304D) present on the cover (300). Thereafter, the nuts (508, 510, 512, 514) are placed and tightened over the protrusions (118A, 118B, 118C, 118D) coming out of the holes (304A, 304B, 304C, 304D). Because of this structure and placement of holes receiving the protrusions, the workpiece (200) is firmly secured, thereby enabling stability which is required for practising the PDR process.

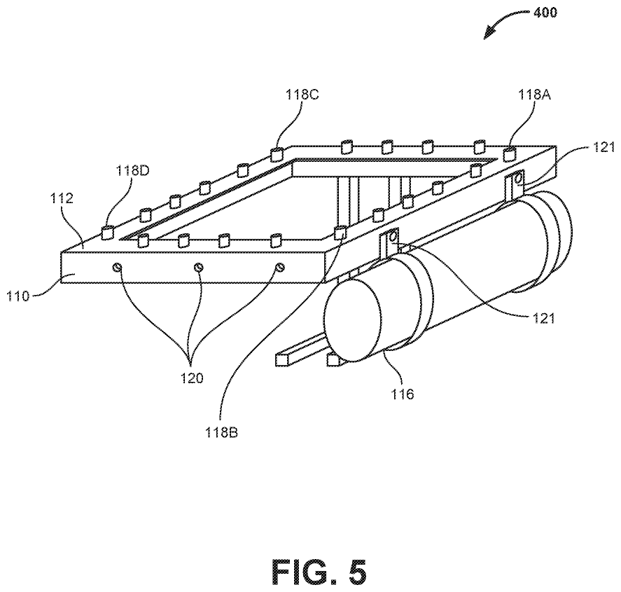

FIG. 5 illustrates another closer perspective view (400) of the apparatus (102). The metallic tube (116) is coupled with the metallic frame (111) with the help of connectors (121). The metallic tube (116) on the side is provided to help practice glue pulling PDR process. Typically, the glue pulling PDR process is used when the user cannot reach to back of a panel on a car, such as the rails of a car. This is the spot on top of the car between the door and the roof. This area has no access to the back, so the user cannot push the dent out. Therefore, the user has to use the glue and glue tabs to the dent and pull them out from the front. The metallic tube (116) represents the rail of a car, the user using the apparatus (102) of the present invention may practice this method as well as other conventional methods.

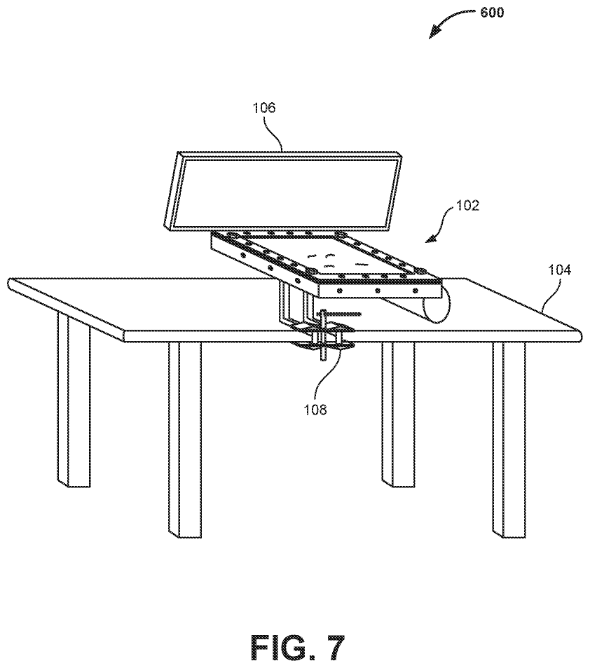

As described above, the side surface (110) of the walls of the metallic frame (111) include holes (120). These holes (120) can act as leverage points or pry points to use other tools (502) as required, as shown in FIG. 6. In an example, as shown, a hook (504) or like means may be mounted on a selected hole (120) present on the side surface (110) of the walls of the metallic frame (111), by means of which the tool (502) can be used for lifting up of the deformative damages (204) areas present on the workpiece (200) so that the damage areas (or dents (204)) are more clearly visible in the presence of the lighting module (106) Further, as shown in the alternative embodiment, the lighting module (106) may be coupled on the metallic frame (111) directly, as shown in FIGS. 6 and 7.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

What is claimed is:

1. An apparatus for practicing removal of a deformative damage to a workpiece, the apparatus comprising:
a metallic frame having a cover disposed thereon, the metallic frame configured to receive the workpiece, wherein a predetermined number of holes are present on a side surface of each wall of the metallic frame and on a top surface of the cover, and wherein protrusions are provided at least at each corner of the metallic frame;
supporting legs connected with the metallic frame at one end and resting on a surface at the other end; and
a securing structure configured to firmly secure the supporting lens on the surface,
wherein the workpiece comprising a plurality of holes at least to receive the protrusions provided at least at each corner of the metallic frame in an event the workpiece is placed on the metallic frame with the cover disposed on the metallic frame.

2. The apparatus as claimed in claim 1 further comprising a metallic tube connected to the metallic frame.

3. The apparatus as claimed in claim 1, wherein the protrusions are provided on a top surface of each wall of the metallic frame, and wherein the holes present on the workpiece are configured to receive the protrusions present on the top surface of the metallic frame.

4. The apparatus as claimed in claim 2, wherein the metallic tube is a cylindrical tube which is configured to be used for practising glue pulling dent removal method.

5. The apparatus as claimed in claim 1, wherein one or more nuts are placed over the protrusions when the protrusions are received by the holes present on the workpiece and the holes present on the cover, wherein the nuts during an operative condition are configured to tightly secure the workpiece in between the metallic frame and the cover when the cover is disposed on the metallic frame.

6. The apparatus as claimed in claim 1, wherein the securing structure is a vice.

7. The apparatus as claimed in claim 1 comprising a lighting module which is configured to throw light on the workpiece during an operative condition.

8. The apparatus as claimed in claim 1, wherein the workpiece is a metallic sheet of size equal to the metallic frame.

9. The apparatus as claimed in claim 1, wherein the holes on the metallic frame are further configured to hold tools utilized in practicing removal of the deformative damage to the workpiece.
